(19) United States
(12) Patent Application Publication
(10) Pub. No.: US 2024/0085521 A1
(43) Pub. Date: Mar. 14, 2024

(54) OBJECT DETECTION DEVICE

(71) Applicant: Mitsubishi Electric Corporation, Tokyo (JP)

(72) Inventor: Katsuyoshi MAEYAMA, Tokyo (JP)

(73) Assignee: Mitsubishi Electric Corporation, Tokyo (JP)

(21) Appl. No.: 17/766,923

(22) PCT Filed: Nov. 25, 2019
(86) PCT No.: PCT/JP2019/045975

§ 371 Date: Apr. 6, 2022

(51) Int. Cl. G01S 7/03; G01S 13/931

(52) U.S. Cl. CPC G01S 7/03; G01S 13/931

(57) ABSTRACT

In a case of performing vertical angle measurement for all detection targets in a detection range, the information amount increases, so that the calculation amount increases and the processing time is prolonged, resulting in a problem that response is deteriorated. Accordingly, this object detection device includes: an object detection unit for detecting an object in a predetermined range; an environment information acquisition unit which acquires environment information in which the object detection unit is placed, and outputs an environment information signal corresponding to the environment information; and a vertical angle measurement function control unit which controls, for the object detection unit, a range for which angle measurement in a vertical direction is performed, on the basis of the environment information signal.

### TECHNICAL FIELD

The present disclosure relates to an object detection device.

### BACKGROUND ART

There have been known advanced driver-assistance systems (ADAS) that assist driving of a vehicle by an adaptive cruise control (ACC) system for keeping the distance between a preceding vehicle and the own vehicle constant and an advanced emergency braking system (AEBS) for detecting an obstacle to provide against collision.

For example, in the AEBS, a detection device such as a camera or a radar for obtaining information about an object present around the own vehicle is mounted on the vehicle, and detects an object present in the moving direction of the own vehicle, as a target object (hereinafter, referred to as a control target) for which control is needed in driving. Then, the positional relationship and the relative velocity between the own vehicle and the control target are observed, and driving assistance control for the own vehicle is performed on the basis of data of the observation result.

Among on-vehicle radars used in the ADAS, the following technology is proposed: the on-vehicle radar is provided with an angle measurement function in the vertical direction with respect to the ground, and on the basis of height information for a detected target (hereinafter, referred to as detection target), whether the detection target is a control target such as a preceding vehicle or a pedestrian, or a non-control target such as a signboard located upward of the road or a thin fallen object on the road, is determined (Patent Document 1).

The content proposed in the above technology is as follows. Since a conventional on-vehicle radar device does not calculate a vertical azimuth, the height of a target from the ground cannot be recognized. Therefore, when a signboard located upward of the road or a thin fallen object on the road is detected, the detected object is erroneously recognized as a frontward target and the ACC system erroneously operates. This is taken as a technical problem, and the above technology aims to solve this problem. That is, as the vertical azimuth which is the azimuth of the detection target in the vertical direction with respect to the ground, the radar device transmits a transmission wave from a transmission antenna to the detection target, and calculates the azimuth of a real image present above the ground on the basis of a reflection wave reflected from the detection target and also calculates the azimuth of a virtual image present underground on the basis of a reflection wave reflected from the ground after reflection from the detection target. Then, the height of the detection target from the ground is calculated using an angle difference between the calculated azimuth of the real image and the calculated azimuth of the virtual image.

That is, Patent Document 1 discloses technology in which information obtained from the detection target is processed, thereby enabling appropriate recognition of a frontward control target without erroneously recognizing a signboard located upward of the road or a thin fallen object on the road as a control target.

### CITATION LIST

### Patent Document

Patent Document 1: Japanese Laid-Open Patent Publication No. 2014-52187

### SUMMARY OF THE INVENTION

### Problems to be Solved by the Invention

In the object detection device proposed in Patent Document 1, information processing is performed by receiving various kinds of information for performing appropriate recognition.

However, if information processing is performed with many kinds of information received, the information amount increases, so that the calculation amount increases and the processing time is prolonged, resulting in a problem that response is deteriorated.

The present disclosure has been made to solve the above problem, and an object of the present disclosure is to provide an object detection device that selects a detection target for which vertical-azimuth angle measurement is performed, on the basis of environment information in which the own vehicle is placed, i.e., environment information in which an object detection unit is placed, thereby enabling reduction in the calculation amount.

### Solution to the Problems

An object detection device according to the present disclosure includes: an object detection unit for detecting a detection target in a predetermined range; an environment information acquisition unit which acquires environment information in which the object detection unit is placed, and outputs an environment information signal corresponding to the environment information; and a vertical angle measurement function control unit which controls, for the object detection unit, a range for which angle measurement in a vertical direction is performed, on the basis of the environment information signal.

### Effect of the Invention

The object detection device according to the present disclosure enables reduction in the calculation amount of signal processing and control in the object detection unit.

### BRIEF DESCRIPTION OF THE DRAWINGS

FIG. 1 is a block diagram showing a configuration in embodiment 1.

FIG. 2 is a flowchart showing operation in embodiment 1.

FIG. 3 is a flowchart showing operation in embodiment 2.

FIG. 4 is a conceptual view showing a coverage in embodiment 3.

FIG. 5 is a conceptual view showing a coverage in embodiment 4.

FIG. 6 is a conceptual view showing a coverage in embodiment 6.

FIG. 7 is a conceptual view showing a coverage in embodiment 7.

FIG. 8 is a conceptual view showing a coverage in embodiment 8.

FIG. 9 is a conceptual view showing a coverage in embodiment 9.

FIG. 10 is a conceptual view showing a coverage in embodiment 10.

FIG. 11 is a block diagram showing a configuration in embodiment 11.

FIG. 12 is a conceptual view showing a mounting state of object detection units in embodiment 11.

FIG. 13 is a block diagram showing a configuration in embodiment 12.

FIG. 14 is a conceptual view showing a mounting state of RF module circuits in embodiment 12.

FIG. 15 is a configuration diagram showing an example of hardware.

### DESCRIPTION OF EMBODIMENTS

### Embodiment 1

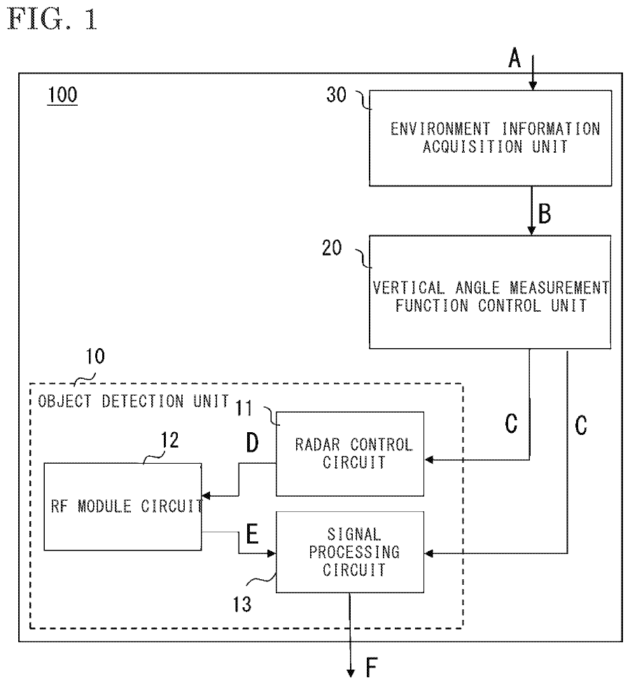

Hereinafter, an object detection device according to embodiment 1 will be described with reference to the FIG. 1.

FIG. 1 is a block diagram showing an object detection device 100 according to embodiment 1. As shown in FIG. 1, the object detection device 100 includes an object detection unit 10, a vertical angle measurement function control unit 20, and an environment information acquisition unit 30.

The object detection unit 10 includes a radar control circuit 11, an RF module circuit 12, and a signal processing circuit 13. The RF module circuit 12 is formed as a board on which a plurality of active components (an IC chip, etc.) and a plurality of passive components (a SAW filter, a capacitor, a resistor, a coil, etc.) are mounted, for example.

In FIG. 1, the environment information acquisition unit 30 acquires information A used for controlling the vertical angle measurement function by means of communication or a sensor. The information A is, for example, the track, the velocity, and the advancing direction of the own vehicle, the relative velocity of a detected object, and the reflection intensity thereof. The information A is referred to as “environment information”. The environment information acquisition unit 30 outputs an environment information signal B based on the acquired information A, to the vertical angle measurement function control unit 20.

On the basis of the environment information signal B, the vertical angle measurement function control unit 20 outputs signals C to the radar control circuit 11 and the signal processing circuit 13 of the object detection unit 10, thus controlling the processing content of at least one of the radar control circuit 11 and the signal processing circuit 13 so as to perform vertical angle measurement processing only for a control target whose state matches a predetermined condition. The control for the processing content is, for example, control of changing ranges about the distance range, the distance accuracy, the velocity range, the velocity accuracy, the angle range, and/or the angle accuracy with which the vertical angle measurement is performed. The signal C for performing such control is a “vertical angle measurement function control signal”. In the object detection unit 10 controlled by the vertical angle measurement function control unit 20, as a vertical azimuth which is the azimuth of an object in the vertical direction with respect to the ground, a real image vertical azimuth which is the azimuth of a real image present above the ground is calculated on the basis of a reflection wave when a transmission wave transmitted from a transmission antenna (not shown) is reflected by an object, and a virtual image vertical azimuth which is the azimuth of a virtual image present underground is calculated on the basis of a reflection wave when a transmission wave transmitted from the transmission antenna is reflected by an object and further reflected by the ground. Then, the object detection unit 10 calculates an angle difference between the calculated real image vertical azimuth and the calculated virtual image vertical azimuth, and calculates the height of the target from the ground, using the calculated angle difference. However, the calculation method for the vertical azimuth by the object detection unit 10 may be any method. For example, the vertical azimuth may be calculated by mechanically or electrically controlling a beam, or it is also possible to calculate the vertical azimuth by a known method such as a beamformer method, super resolution angle measurement, or monopulse angle measurement.

The radar control circuit 11 performs control about transmission and reception of radio waves, for the RF module circuit 12. The control about transmission and reception of radio waves is, for example, control about a frequency band of a transmission wave, an occupied frequency band, a sampling frequency, a sampling number, a frequency modulation time, a transmission CH, a reception CH, and a frequency modulation timing. In performing this control, the content of the control can be changed on the basis of the signal C.

The RF module circuit 12 transmits and receives radio waves in accordance with an RF module circuit control signal D, and measures a beat signal E.

The signal processing circuit 13 performs frequency analysis on the beat signal E, thereby calculating, for example, the distance to an object, the relative velocity, the azimuth angle, the elevation angle, and the reflection intensity for the object, and outputs the result thereof as an output signal F. In performing this signal processing, the content of the signal processing can be changed on the basis of the vertical angle measurement function control signal C. It is noted that arrows in FIG. 1 indicate flows of signals.

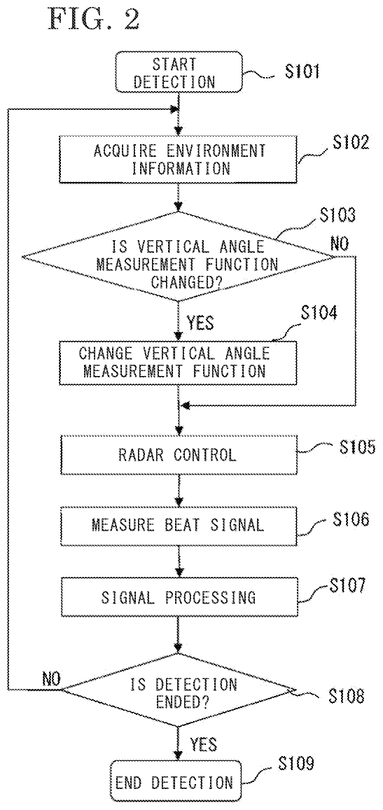

Next, operation in embodiment 1 will be described with reference to FIG. 2. FIG. 2 is a flowchart showing the operation in embodiment 1.

In step S101, detection is started, and in step S102, the environment information acquisition unit 30 acquires the environment information by means of communication or a sensor, and the vertical angle measurement function control unit 20 receives the environment information signal B.

In step S103, the vertical angle measurement function control unit 20 determines the control content of the vertical angle measurement function on the basis of the environment information, and determines whether or not the control content has been changed from that in the previous cycle. If the control content has been changed, the process proceeds to step S104, and otherwise, the process proceeds to radar control in step S105. In step S104, the vertical angle measurement function control unit 20 outputs the signal C which is the vertical angle measurement function control signal so as to change the preset processing content of at least one of the radar control circuit 11 or the signal processing circuit 13 in accordance with the control content determined in step S103.

In step S105, the radar control circuit 11 controls the RF module circuit 12 on the basis of the preset processing content.

In step S106, the RF module circuit 12 transmits and receives radio waves and measures a beat signal, on the basis of the RF module circuit control signal D from the radar control circuit 11.

In step S107, the signal processing circuit 13 performs signal processing on the beat signal E on the basis of the preset processing content, and calculates the distance to the detected object, the velocity, the azimuth angle, the elevation angle, the signal intensity for the object, and the like.

If it is determined that the detection is ended in step S108, the detection is ended in step S109. If it is not determined that the detection is ended, the process returns to step S102, to repeat acquisition for the environment information.

Through the operation shown in the flowchart, control of the vertical angle measurement function of the radar is performed on the basis of the environment information. As a result, if the vertical angle measurement function need not be changed on the basis of the environment information, the angle measurement function is not changed, and thus wasteful communication or calculation can be omitted.

### Embodiment 2

A configuration in the present embodiment 2 is the same as that in embodiment 1. The difference is operation performed with this configuration.

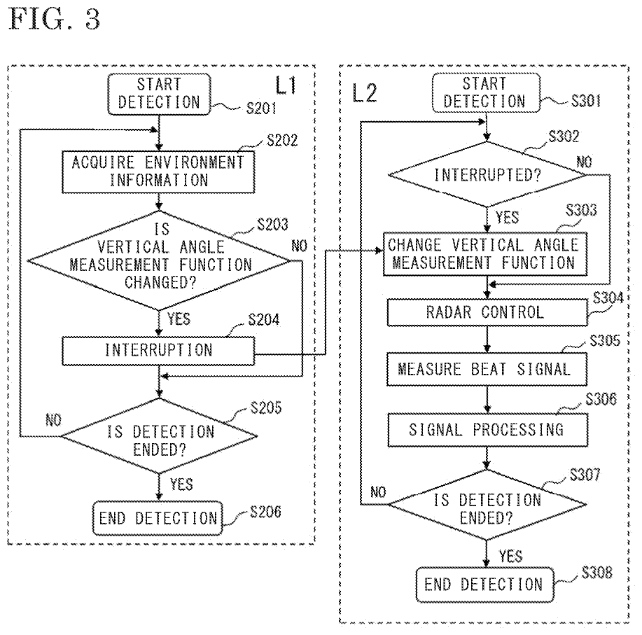

FIG. 3 is a flowchart showing the operation in the present embodiment 2. The difference between the operation in the present embodiment 2 and the operation in embodiment 1 will be described below.

In embodiment 2, in contrast to the processing flow in embodiment 1, a processing flow for performing control of the vertical angle measurement function and a processing flow for performing detection for an object are performed in parallel.

The processing flow for determining whether or not to perform control of the vertical angle measurement function is referred to as a “vertical angle measurement function control determination loop L1”, and the processing flow for performing detection for an object is referred to as an “object detection processing loop L2”.

In the vertical angle measurement function control determination loop L1, in step S201, detection is started, and in step S202, the environment information acquisition unit 30 acquires the environment information by means of communication or a sensor, and the vertical angle measurement function control unit 20 receives the environment information signal B. In step S203, the vertical angle measurement function control unit 20 determines the control content of the vertical angle measurement function on the basis of the environment information signal B, and determines whether or not the control content has been changed from that in the previous cycle. At this time, if the control content has been changed, the process proceeds to step S204, to perform “interruption to the object detection processing loop L2”, and if the control content has not been changed, the process proceeds to step S205.

In the object detection processing loop L2, in step S301, detection is started, and in step S302, whether or not interruption has occurred is determined. If interruption has occurred, the process proceeds to step S303, and otherwise, the process proceeds to radar control in step S304. In step S303, the vertical angle measurement function control unit 20 outputs the signal C which is the vertical angle measurement function control signal so as to change the preset processing content of at least one of the radar control circuit 11 or the signal processing circuit 13 in accordance with the control content determined in step S303.

In step S304, the radar control circuit 11 controls the RF module circuit 12 on the basis of the preset processing content.

In step S305, the RF module circuit 12 transmits and receives radio waves and measures a beat signal, on the basis of the RF module circuit control signal D from the radar control circuit 11.

In step S306, the signal processing circuit 13 performs signal processing on the beat signal E on the basis of the preset processing content, and calculates the distance to the detected object.

If it is determined that the detection is ended in step S307, the detection is ended in step S308. If it is not determined that the detection is ended, the process returns to step S302, to repeat acquisition for the environment information.

In step S204, if “interruption to the object detection processing loop L2” is performed, the vertical angle measurement function control unit 20 generates step S303 in the object detection processing loop. On the other hand, if the interruption has not occurred, step S303 is not generated.

In step S205, if it is determined that the detection is ended, the detection is ended in step S206. If it is not determined that the detection is ended, the process returns to step S202, to perform subsequent processing in the same manner.

In the object detection processing loop L2, in step S302, whether or not interruption from the vertical angle measurement function control determination loop has occurred is determined. If the interruption has occurred, the process proceeds to step S303, and if the interruption has not occurred, the process proceeds to step S304.

In step S303, the vertical angle measurement function control unit 20 outputs the vertical angle measurement function control signal C so as to control the processing content of at least one of the radar control circuit 11 or the signal processing circuit 13 in accordance with the control content preset in step S203 of the vertical angle measurement function control determination loop L1.

With this configuration, signal processing can be performed in parallel between the vertical angle measurement function control determination loop L1 and the object detection processing loop L2. Therefore, the cycle of the object detection and the cycle of the vertical angle measurement function control can be separated to be independent of each other, whereby more flexible system designing can be performed while the same effects as in embodiment 1 are provided. In addition, since step S303 is set at a stage before step S304, the change content for the vertical angle measurement function can be consistent between the radar control circuit 11 and the signal processing circuit 13.

### Embodiment 3

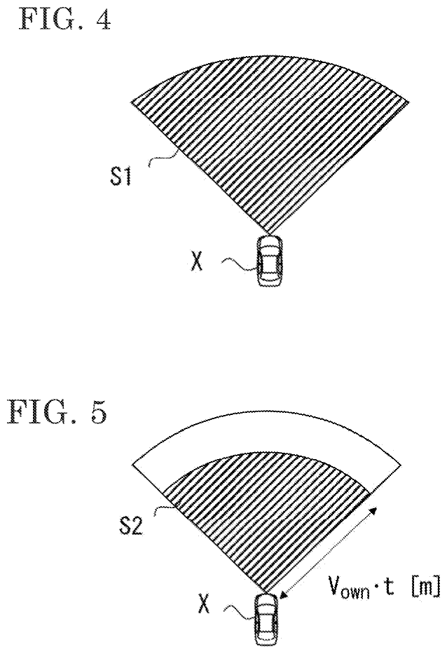

FIG. 4 is a conceptual view showing a coverage of the radar. The environment information acquisition unit 30 acquires the velocity of the own vehicle X, and the vertical angle measurement function control unit 20 controls the object detection unit 10 so as to perform angle measurement in the vertical direction only for an object whose absolute velocity V_{target} is not greater than a threshold Vth among detected objects. For example, in a case where a hatched area S1 in FIG. 4 is the detection range of the radar, the object detection unit 10 is controlled so as to take, as a vertical angle measurement target, only an object whose absolute velocity V_{target} is not greater than the threshold Vth, thereby controlling transmission and reception of radio waves and signal processing.

Thus, a still object which is a non-control target such as a signboard located upward of the road or a thin fallen object on the road, and a control target staying still such as a vehicle stopping due to congestion, can be distinguished by height difference, and at the same time, control can be performed so as not to perform vertical angle measurement for a control target that is moving such as a vehicle traveling at the front, whereby it becomes possible to efficiently perform radar control and signal processing.

### Embodiment 4

FIG. 5 is a conceptual view showing a coverage of the radar. The environment information acquisition unit 30 acquires a velocity V_{own} of the own vehicle X and a specified time, and the vertical angle measurement function control unit 20 controls the object detection unit 10 so as to perform angle measurement in the vertical direction only for the distance range in which the own vehicle can move within the specified time. For example, in a case where the own vehicle velocity is V_{own}[m/S] and the specified time is t [S], as shown in a hatched area S2 in FIG. 5, the distance range for which vertical angle measurement is performed is set within V_{own}·t[m].

Thus, it is possible to refrain from performing vertical angle measurement for an object at a distance to which the own vehicle cannot move within the specified time, whereby it becomes possible to efficiently perform radar control and signal processing.

### Embodiment 5

The environment information acquisition unit 30 acquires information about at least one of the present velocity V_{own}, a target velocity, a deceleration, and a jerk of the own vehicle X, and a set value of the minimum inter-vehicle distance, and the vertical angle measurement function control unit 20 controls the object detection unit 10 so as to perform angle measurement in the vertical direction for a distance range within a distance obtained by adding the minimum inter-vehicle distance to the distance by which the own vehicle will move until reaching the target velocity. The set value of the minimum inter-vehicle distance may be prescribed from the inter-vehicle time between the own vehicle and the preceding vehicle, or may be changed dynamically. The set value of the minimum inter-vehicle distance may be always set to 0 [m] and thus may be omitted. A conceptual view showing a coverage of the radar in this embodiment 55 is the same as that shown in FIG. 5 in embodiment 4.

Thus, even in a case where a still object present in the advancing direction of the own vehicle is a control target, it is possible to determine whether or not the still object is a control target from the distance where collision with the control target can be avoided.

It is noted that embodiment 4 and the present embodiment may be combined such that the present embodiment is applied to only a case where the own vehicle decelerates and embodiment 4 is applied to a case other than the case where the own vehicle decelerates. Thus, it is possible to determine a target for which the vertical angle measurement is performed, in accordance with the condition of acceleration/deceleration of the own vehicle.

### Embodiment 6

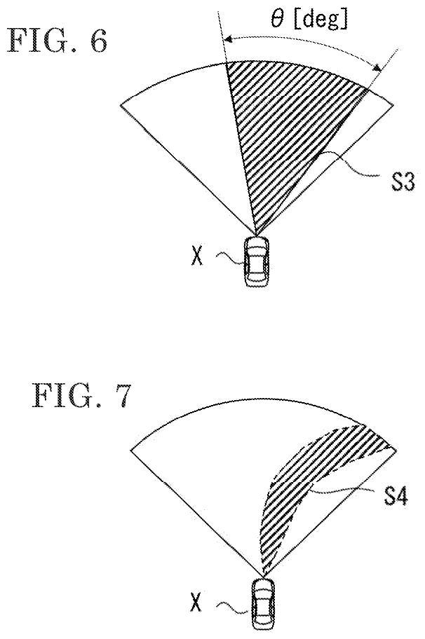

FIG. 6 is a conceptual view showing a coverage of the radar. The environment information acquisition unit 30 acquires a horizontal angle direction in which the own vehicle X will move, and the vertical angle measurement function control unit 20 controls the object detection unit 10 so as to perform angle measurement in the vertical direction only for a horizontal angle range θ[deg] in which the own vehicle X will move. For example, in a case where the own vehicle X will move right frontward, the horizontal angle range θ[deg] for which vertical angle measurement is performed is limited to the right frontward area as shown in a hatched area S3 in FIG. 6.

Thus, vertical angle measurement for an object in a direction other than the advancing direction of the own vehicle X can be omitted, whereby it becomes possible to efficiently perform radar control and signal processing.

### Embodiment 7

FIG. 7 is a conceptual view showing a coverage of the radar. The environment information acquisition unit 30 acquires track information through which the own vehicle X will move, and the vertical angle measurement function control unit 20 controls the object detection unit 10 so as to perform angle measurement in the vertical direction only for a range on the track through which the own vehicle X will move. For example, in a case where the own vehicle X will turn right, the distance range and the horizontal angle range for which vertical angle measurement is performed are limited to only the area around the right-turn track, as shown in a hatched area S4 in FIG. 7. At this time, angle measurement in the vertical direction may be performed for a range obtained by adding a margin for track acquisition error to the track of the own vehicle X.

Thus, the range other than a range on the advancing track of the own vehicle X or a range obtained by adding a margin to the track can be excluded from the distance range and the horizontal angle range for which vertical angle measurement is performed, whereby it becomes possible to efficiently perform radar control and signal processing.

### Embodiment 8

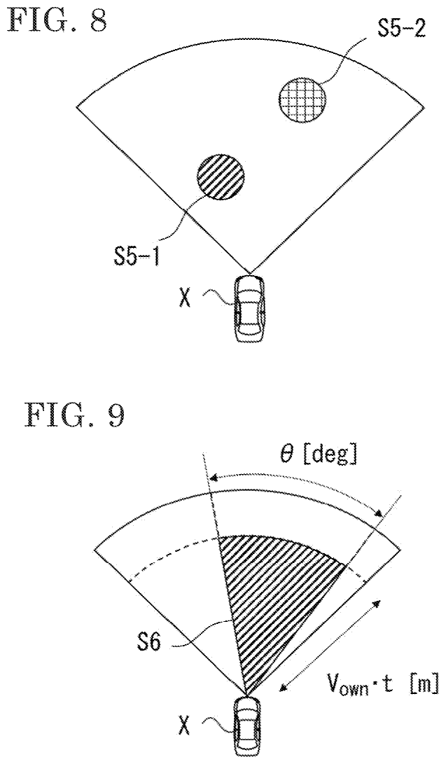

FIG. 8 is a conceptual view showing a coverage of the radar. The environment information acquisition unit 30 acquires a signal-to-noise ratio (SNR) for a detection target and a threshold for the SNR. For an object for which the SNR is low, angle measurement accuracy is reduced. Therefore, the vertical angle measurement function control unit 20 controls the object detection unit 10 so as to perform angle measurement in the vertical direction only for a detection target for which the SNR exceeds the threshold. For example, in a case where the threshold for the SNR is set at 5 db, if the SNR for a hatched area S5-1 in FIG. 8 is 10 db, it is determined that there is an object for which the SNR exceeds the threshold, and angle measurement in the vertical direction is performed therefor. On the other hand, if the SNR for a lattice area S5-2 is 0 db, it is determined that there is an object for which the SNR is smaller than the threshold, and vertical angle measurement is not performed therefor.

Thus, it is possible to omit vertical angle measurement for a road surface or a low-position object for which the SNR is low, whereby it becomes possible to efficiently perform radar control and signal processing. At this time, instead of the SNR, on the basis of a reflection signal intensity for a detection target, the vertical angle measurement function control unit 20 may control the object detection unit 10 so as to perform angle measurement in the vertical direction only for a detection target for which the reflection signal intensity exceeds a threshold.

It is noted that the present embodiment may be applied at the same time as the range for which angle measurement in the vertical direction is performed is limited in another embodiment.

### Embodiment 9

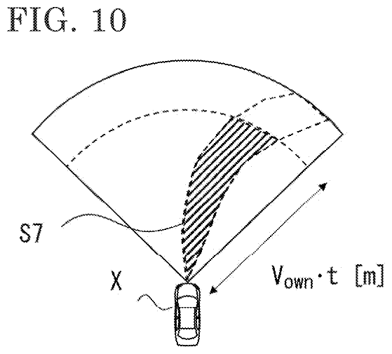

FIG. 9 is a conceptual view showing a coverage of the radar. The environment information acquisition unit 30 acquires the velocity of the own vehicle X, a threshold for still object determination, a specified time, and a horizontal direction in which the own vehicle X will move. Then, the vertical angle measurement function control unit 20 performs still object determination for a detection target on the basis of the own vehicle velocity, the threshold for still object determination, and the relative velocity of the detection target, and controls the object detection unit 10 so as to perform angle measurement in the vertical direction only for a still object within the distance and the angle range where the own vehicle X is expected to move within the specified time. For example, as shown in a hatched area S6 in FIG. 9, in a case where the velocity of the own vehicle X is V_{own} [m/S] and the specified time is t [S], the distance range for which vertical angle measurement is performed is set within V_{own}·t [m], the horizontal angle range θ[deg] is limited to only the right frontward area, and vertical angle measurement is performed only for a still object.

Thus, a still object which is a non-control target such as a signboard above the road or a fallen object thereon, and a control target staying still such as a vehicle stopping due to congestion, can be distinguished by height difference, and at the same time, vertical angle measurement is not performed for a control target that is moving such as a vehicle traveling at the front. In addition, it is possible to omit vertical angle measurement for an object that will apparently not collide with the own vehicle X, such as a still object at a distance to which the own vehicle X cannot move within the specified time or a still object in a direction other than the advancing direction of the own vehicle X, whereby it becomes possible to efficiently perform radar control and signal processing.

### Embodiment 10

FIG. 10 is a conceptual view showing a coverage of the radar. The environment information acquisition unit 30 acquires the velocity of the own vehicle X, a threshold for still object determination, a specified time, and a track through which the own vehicle X will move, and the vertical angle measurement function control unit 20 controls the object detection unit 10 so as to perform angle measurement in the vertical direction only for a still object within the distance and the angle range where the own vehicle X is expected to move within the specified time. For example, as shown in a hatched area S7 in FIG. 10, in a case where the velocity of the own vehicle X is V_{own} [m/S] and the specified time is t [S], the distance range for which vertical angle measurement is performed is set within V_{own}·t [m], the distance range and the horizontal angle range are limited to only the area around the right-turn track, and vertical angle measurement is performed only for a still object.

Thus, a still object which is a non-control target such as a signboard above the road or a fallen object thereon, and a control target staying still such as a vehicle stopping due to congestion, can be distinguished by height difference, and at the same time, vertical angle measurement is not performed for a control target that is moving such as a vehicle traveling at the front. In addition, it is possible to omit vertical angle measurement for an object that will apparently not collide with the own vehicle X, such as a still object at a distance to which the own vehicle X cannot move within the specified time or a still object at an area other than the advancing track of the own vehicle X, whereby it becomes possible to efficiently perform radar control and signal processing.

### Embodiment 11

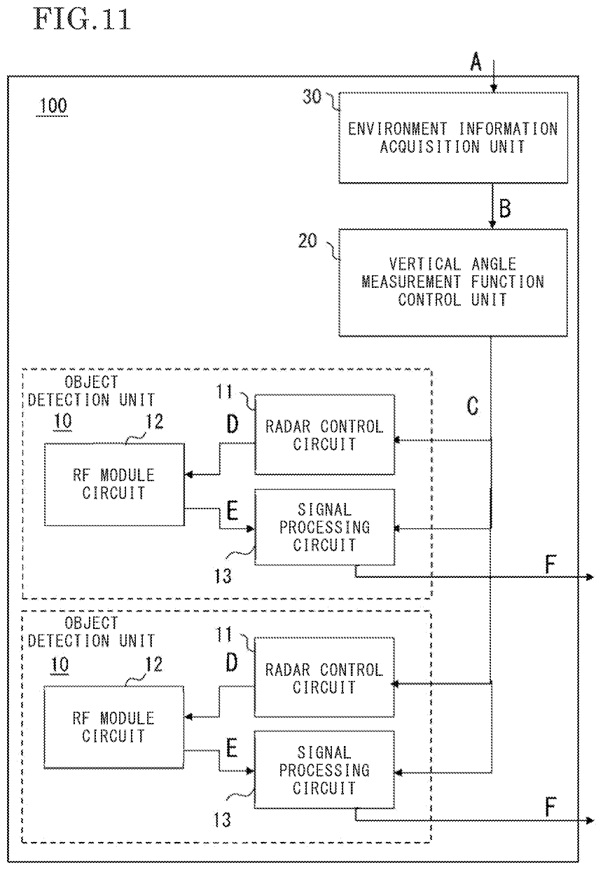

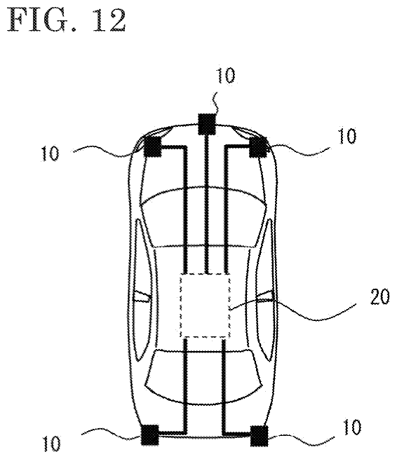

FIG. 11 is a block diagram showing an object detection device 100 according to embodiment 11. FIG. 12 is a configuration diagram showing a state in which the object detection device 100 of embodiment 11 is mounted on a vehicle.

The configuration in embodiment 11 is the same as those in embodiment 1 and embodiment 2, except for the object detection unit 10. In this embodiment 11, the object detection units 10 are provided at three locations on the front side and two locations on the rear side of the own vehicle X. In addition, the vertical angle measurement function control unit 20 is mounted inside the own vehicle X. It is noted that the other parts are mounted inside the own vehicle X, as with the vertical angle measurement function control unit 20.

Thus, it becomes possible to perform control of the vertical angle measurement function for a coverage obtained by combining the coverages of a plurality of object detection units 10, and it becomes possible to perform cooperation between the plurality of object detection units.

### Embodiment 12

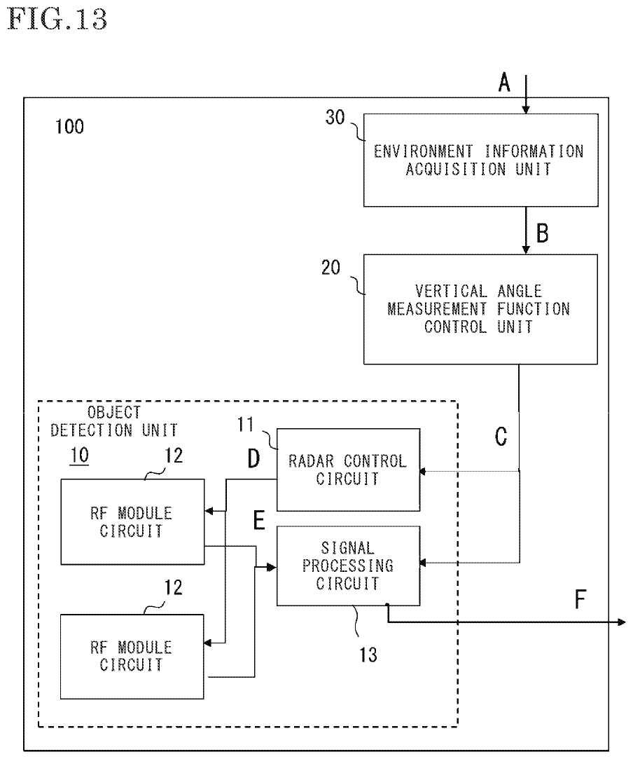

FIG. 13 is a block diagram showing an object detection unit 10, a vertical angle measurement function control unit 20, and an environment information acquisition unit 30 of an object detection device 100 according to embodiment 12.

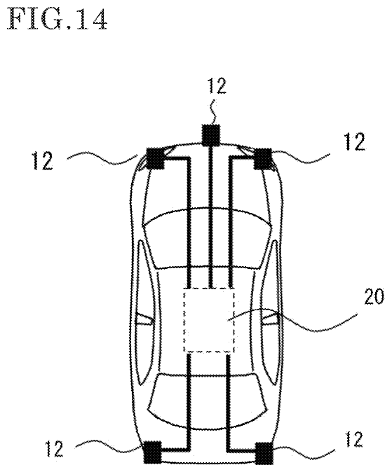

FIG. 14 is a configuration diagram showing a state in which the object detection device 100 of embodiment 12 is mounted on a vehicle.

The configuration in embodiment 12 is the same as those in embodiment 1, embodiment 2, and embodiment 11, except for the object detection unit 10, and is different in that the object detection unit 10 includes a plurality of RF module circuits 12, one signal processing circuit 13, and one or more radar control circuits 11. As shown in FIG. 14, the RF module circuits 12 are provided at three locations on the front side and two locations on the rear side of the own vehicle X. In addition, the vertical angle measurement function control unit 20 is mounted inside the own vehicle X, and the radar control circuit 11 may be mounted inside the vehicle X or may be mounted at the same locations as the RF module circuits 12.

It is noted that the other parts are mounted inside the own vehicle X, as with the vertical angle measurement function control unit 20.

Thus, such a condition that all the RF module circuits 12 are required to have maximum performances at the same time is eliminated, whereby it is possible to realize an equivalent function even with lower processing performance than the sum of processing performances required in individual signal processing circuits 13 of a plurality of object detection units 10.

In embodiments 1 to 12, the case of using the radar has been described. However, the above configurations can be applied to any sensor such as a radar or light detection and ranging (LiDAR) that can measure at least one of a distance, a velocity, or an angle, has a vertical angle measurement function, and can change at least one of a distance range, distance accuracy, a velocity range, velocity accuracy, an angle range, or angle accuracy with which vertical angle measurement is performed.

In particular, in the case of a radar, a configuration of calculating a vertical azimuth by a known method such as a beamformer method, super resolution angle measurement, or monopulse angle measurement is often adopted. Therefore, the effect of processing load reduction by limiting the range for which vertical angle measurement is performed is great.

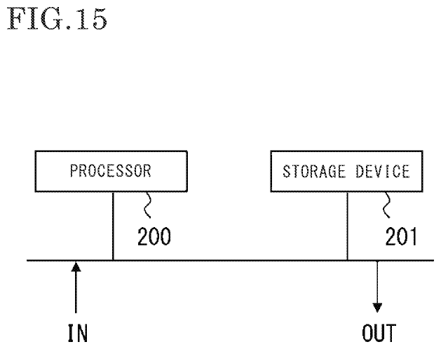

As shown in FIG. 15 which shows an example of a hardware configuration, the object detection unit 10, the vertical angle measurement function control unit 20, and the environment information acquisition unit 30 are configured from a processor 200 and a storage device 201. The storage device is provided with a volatile storage device such as a random access memory and a nonvolatile auxiliary storage device such as a flash memory, although not shown. Instead of a flash memory, an auxiliary storage device of a hard disk may be provided. The processor 200 executes a program inputted from the storage device 201. In this case, the program is inputted from the auxiliary storage device to the processor 200 via the volatile storage device. In addition, the processor 200 may output data such as a calculation result to the volatile storage device of the storage device 201, or may store such data into the auxiliary storage device via the volatile storage device.

The RF module circuit, the radar control circuit, and the signal processing circuit, which have been described as components of the object detection unit, may not necessarily be stored in one housing. For example, a circuit for performing a part or the entirety of processing of the signal processing circuit may be mounted in another housing (signal processing electronic control unit (ECU)) mounted at a location different from the RF module circuit.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

0 object detection unit
11 radar control circuit
12 RF module circuit
13 signal processing circuit
20 vertical angle measurement function control unit
30 environment information acquisition unit
100 object detection device
200 processor
201 storage device

1. An object detection device comprising:
an object detector for detecting a detection target in a predetermined range;
an environment information acquirer which acquires environment information in which the object detector is placed, and outputs an environment information signal corresponding to the environment information; and
a vertical angle measurement function controller which controls, for the object detector a range for which angle measurement in a vertical direction is performed, on the basis of the environment information signal.

2. The object detection device according to claim 1, wherein
the object detector includes a radar control circuit, an RF module circuit, and a signal processing circuit.

3. The object detection device according to claim 2, wherein
the object detector includes a plurality of the RF module circuits.

4. The object detection device according to claim 1, wherein
a plurality of the object detector are provided and the vertical angle measurement function controller controls the plurality of object detector.

5. The object detection device according to claim 1, wherein
the vertical angle measurement function controller controls a function of the object detector regarding the angle measurement in the vertical direction, to change at least one or more of a distance range, a distance accuracy, a velocity range, a velocity accuracy, an angle range, and an angle accuracy with which the vertical angle measurement is performed.

6. The object detection device according to claim 1, wherein
the environment information acquirer acquires information about one or more of a track of a vehicle, a velocity thereof, an advancing direction thereof, a relative velocity of a detected object, a SNR thereof, and a reflection signal intensity thereof, as information for the vertical angle measurement function controller to perform control for the object detector.

7. The object detection device according to claim 1, wherein
the vertical angle measurement function controller determines whether or not the detection target is a still object, and performs control so that the vertical angle measurement is performed only for the still object.

8. The object detection device according to claim 1, the object detection device being mounted on a vehicle, wherein
the vertical angle measurement function controller controls a distance range for which the vertical angle measurement is performed, on the basis of a velocity of the own vehicle.

9. The object detection device according to claim 1, the object detection device being mounted on a vehicle, wherein
the vertical angle measurement function controller controls a distance range for which the vertical angle measurement is performed, on the basis of a distance by which the own vehicle will move until reaching a target velocity.

10. The object detection device according to claim 1, the object detection device being mounted on a vehicle, wherein
the vertical angle measurement function controller controls a horizontal angle range for which the vertical angle measurement is performed, on the basis of an advancing direction of the own vehicle.

11. The object detection device according to claim 1, the object detection device being mounted on a vehicle, wherein
the vertical angle measurement function controller controls one or more of a distance range and a horizontal angle range for which the vertical angle measurement is performed, on the basis of track information of the own vehicle.

12. The object detection device according to claim 1, wherein
the vertical angle measurement function controller performs control, on the basis of a SNR of a reflection signal from the detection target, so that the vertical angle measurement is performed only for the detection target for which the SNR is higher than a threshold.

13. The object detection device according to claim 1, wherein
the vertical angle measurement function controller performs control, on the basis of an intensity of a reflection signal from the detection target, so that the vertical angle measurement is performed only for the detection target for which the intensity of the reflection signal is higher than a threshold.
